(19) United States
(12) Patent Application Publication
(10) Pub. No.: US 2024/0406775 A1
(43) Pub. Date: Dec. 5, 2024

(54) USER EQUIPMENT TO CLOUD REPORTING FOR MODE 2 SIDELINK PARAMETER COORDINATION

(71) Applicant: QUALCOMM Incorporated, San Diego, CA (US)

(72) Inventors: Libin LIU, Monterey Park, CA (US); Stelios STEFANATOS, San Diego, CA (US); Arthur GUBESKYS, San Diego, CA (US); Tien Viet NGUYEN, Bridgewater, NJ (US); Gabi SARKIS, San Diego, CA (US); Guangyi LIU, Shanghai (CN); Shuanshuan WU, San Diego, CA (US)

(21) Appl. No.: 18/697,857

(22) PCT Filed: Dec. 13, 2022
(86) PCT No.: PCT/US2022/081455

§ 371 Date: Apr. 2, 2024

(30) Foreign Application Priority Data
Dec. 22, 2021 (GR) 20210100906

(51) Int. Cl. H04W 24/10; H04W 72/25

(52) U.S. Cl. CPC H04W 24/10; H04W 72/25

(57) ABSTRACT

Various aspects of the present disclosure generally relate to wireless communication. In some aspects, a user equipment (UE) may receive, from a cloud-based platform, a configuration for Mode 2 sidelink measurement reporting. The configuration is associated with a plurality of UEs in a particular geographic area. The UE is included among the plurality of UEs. The UE may transmit, to the cloud-based platform, a Mode 2 sidelink measurement report based at least in part on the configuration. Numerous other aspects are described.

### CROSS-REFERENCE TO RELATED APPLICATION

This patent application claims priority to Greek patent application No. 20210100906, filed on Dec. 22, 2021, entitled “USER EQUIPMENT TO CLOUD REPORTING FOR MODE 2 SIDELINK PARAMETER COORDINATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for user equipment (UE) to cloud reporting for Mode 2 sidelink parameter coordination.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a cloud-based platform, a configuration for Mode 2 sidelink measurement reporting, where the configuration is associated with a plurality of UEs in a particular geographic area, and where the UE is included among the plurality of UEs. The method may include transmitting, to the cloud-based platform, a Mode 2 sidelink measurement report based at least in part on the configuration.

Some aspects described herein relate to a method of wireless communication performed by a cloud-based platform. The method may include transmitting a configuration for Mode 2 sidelink measurement reporting to a plurality of UEs in a particular geographic area. The method may include receiving, from at least a subset of the plurality of UEs, Mode 2 sidelink measurement reports based at least in part on the configuration.

Some aspects described herein relate to a UE for wireless communication. The user equipment may include a memory and one or more processors coupled to the memory. The one or more processors may be configured to receive, from a cloud-based platform, a configuration for Mode 2 sidelink measurement reporting. The one or more processors may be configured to transmit, to the cloud-based platform, a Mode 2 sidelink measurement report based at least in part on the configuration.

Some aspects described herein relate to a cloud-based platform for wireless communication. The cloud-based platform may include a memory and one or more processors coupled to the memory. The one or more processors may be configured to transmit a configuration for Mode 2 sidelink measurement reporting to a plurality of UEs in a particular geographic area. The one or more processors may be configured to receive, from at least a subset of the plurality of UEs, Mode 2 sidelink measurement reports based at least in part on the configuration.

Some aspects described herein relate to a non-transitory computer-readable medium that stores a set of instructions for wireless communication by a user equipment (UE). The set of instructions, when executed by one or more processors of the UE, may cause the UE to receive, from a cloud-based platform, a configuration for Mode 2 sidelink measurement reporting. The set of instructions, when executed by one or more processors of the UE, may cause the UE to transmit, to the cloud-based platform, a Mode 2 sidelink measurement report based at least in part on the configuration.

Some aspects described herein relate to a non-transitory computer-readable medium that stores a set of instructions for wireless communication by a cloud-based platform. The set of instructions, when executed by one or more processors of the cloud-based platform, may cause the cloud-based platform to transmit a configuration for Mode 2 sidelink measurement reporting to a plurality of UEs in a particular geographic area. The set of instructions, when executed by one or more processors of the cloud-based platform, may cause the cloud-based platform to receive, from at least a subset of the plurality of UEs, Mode 2 sidelink measurement reports based at least in part on the configuration.

Some aspects described herein relate to an apparatus for wireless communication. The apparatus may include means for receiving, from a cloud-based platform, a configuration for Mode 2 sidelink measurement reporting, where the configuration is associated with a plurality of apparatuses in a particular geographic area, and where the apparatus is included among the plurality of apparatuses. The apparatus may include means for transmitting, to the cloud-based platform, a Mode 2 sidelink measurement report based at least in part on the configuration.

Some aspects described herein relate to an apparatus for wireless communication. The apparatus may include means for transmitting a configuration for Mode 2 sidelink measurement reporting to a plurality of UEs in a particular geographic area. The apparatus may include means for receiving, from at least a subset of the plurality of UEs, Mode 2 sidelink measurement reports based at least in part on the configuration.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram of an example environment, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIGS. 6A-6D and 7 are diagrams illustrating examples associated with UE-to-cloud reporting for Mode 2 sidelink parameter coordination, in accordance with the present disclosure.

FIGS. 8 and 9 are diagrams illustrating example processes associated with UE-to-cloud reporting for Mode 2 sidelink parameter coordination, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

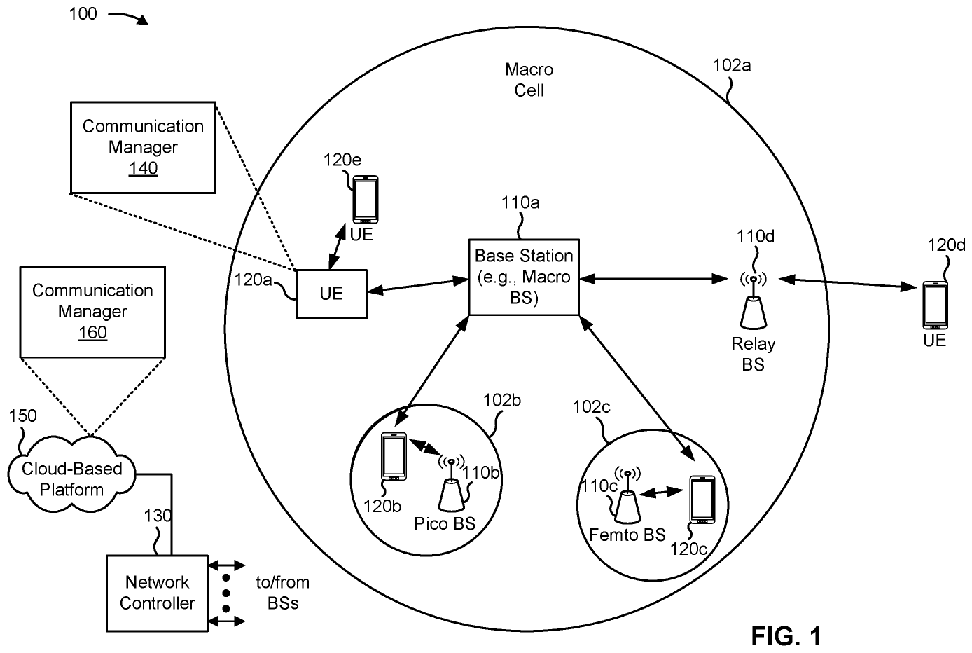

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

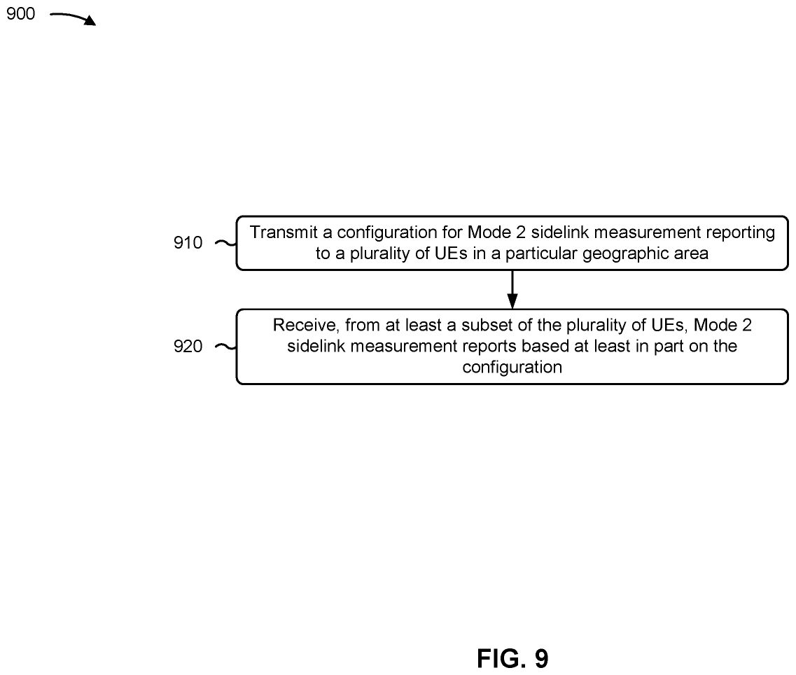

In some aspects, the terms “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station,” “network node,” or “network entity” may refer to one device configured to perform one or more functions, such as those described herein in connection with the base station 110. In some aspects, the terms “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station,” “network node,” or “network entity.” may refer to any one or more of those different devices. In some aspects, the terms “base station,” “network node,” or “network entity” may refer to one or more virtual base stations and/or one or more virtual base station functions. For example, in some aspects, two or more base station functions may be instantiated on a single device. In some aspects, the terms “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

In some examples, a UE 120 may include a roadside unit (RSU). An RSU includes a type of UE 120 that is typically located along a road or street and communicates with other UEs 120 (e.g., UEs 120 associated with a vehicle. UEs 120 associated with a user that is traveling along a road or street) on a sidelink. The RSU also communicates with one or more base stations 110. An RSU may provide UE transmissions from a UE 120 to a base station 110 and/or may provide transmissions from a base station 110 to a UE 120.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHz). FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a cloud-based platform 150, a configuration for Mode 2 sidelink measurement reporting, wherein the configuration is associated with a plurality of UEs 120 in a particular geographic area, and wherein the UE 120 is included among the plurality of UEs 120 and transmit, to the cloud-based platform 150, a Mode 2 sidelink measurement report based at least in part on the configuration. Additionally, or alternatively, the communication manager 140 may perform one or more other operations described herein.

In some examples, a cloud-based platform 150 may communicate with one or more network controllers 130, to transmit communications to and/or receive communications from one or more wireless communication devices in the wireless network 100. For example, the cloud-based platform 150 may communicate with one or more base stations 110 (e.g., directly or through one or more network controllers 130). As another example, the cloud-based platform 150 may communicate with one or more UEs 120 (e.g., directly or through one or more network controllers 130), such as one or more RSUs, one or more UEs associated with vehicles, and/or one or more UEs associated with users, among other examples.

The cloud-based platform 150 may be configured to coordinate sidelink parameters for communication on one or more sidelinks between UEs 120 in the wireless network 100. In some examples, the cloud-based platform 150 is implemented by one or more network controllers 130 or is implemented by one or more devices that also implement the network controllers 130.

In some aspects, the cloud-based platform may include a communication manager 160. As described in more detail elsewhere herein, the communication manager 160 may transmit a configuration for Mode 2 sidelink measurement reporting to a plurality of UEs 120 in a particular geographic area; and receive, from at least a subset of the plurality of UEs 120, Mode 2 sidelink measurement reports based at least in part on the configuration. Additionally, or alternatively, the communication manager 160 may perform one or more other operations described herein.

As indicated above, FIG. 1 is provided as an example. Other examples may differ from what is described with regard to FIG. 1.

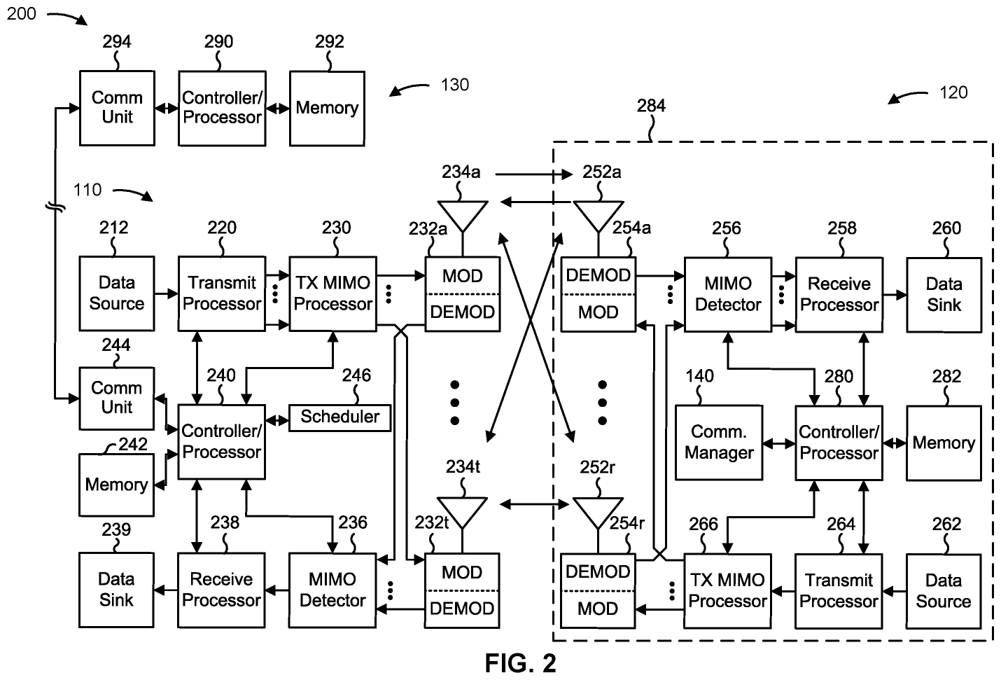

FIG. 2 is a diagram illustrating an example 200 of a base station 110 in communication with a UE 120 in a wireless network 100, in accordance with the present disclosure. The base station 110 (or another type of network node) may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

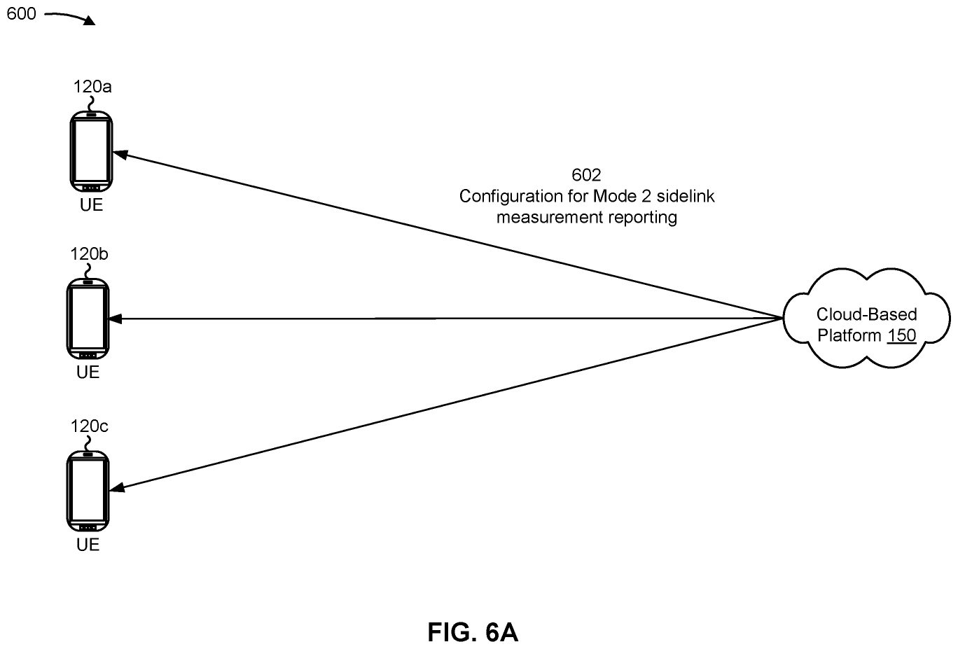

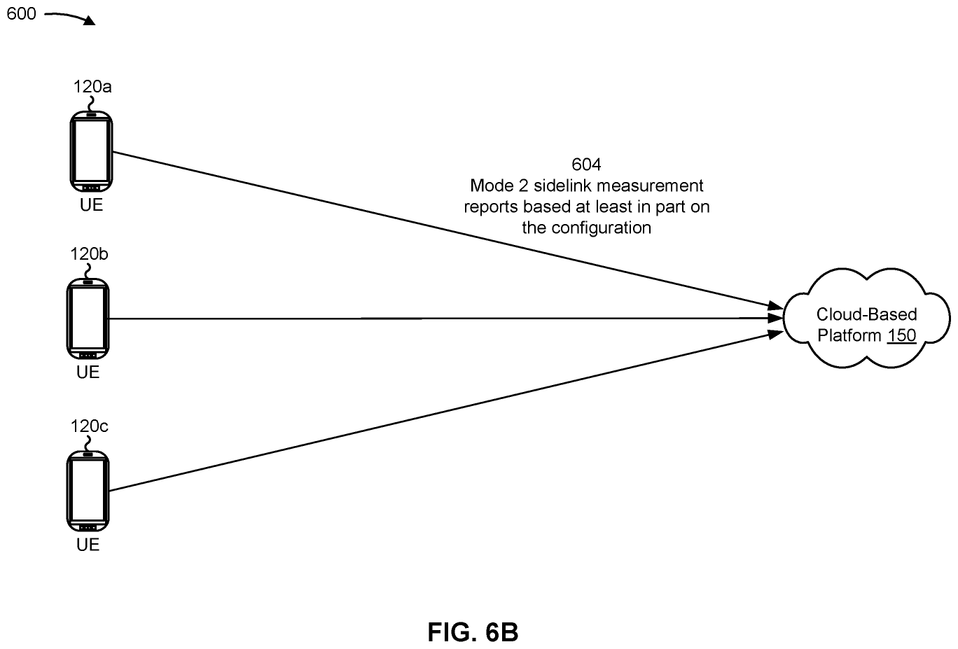

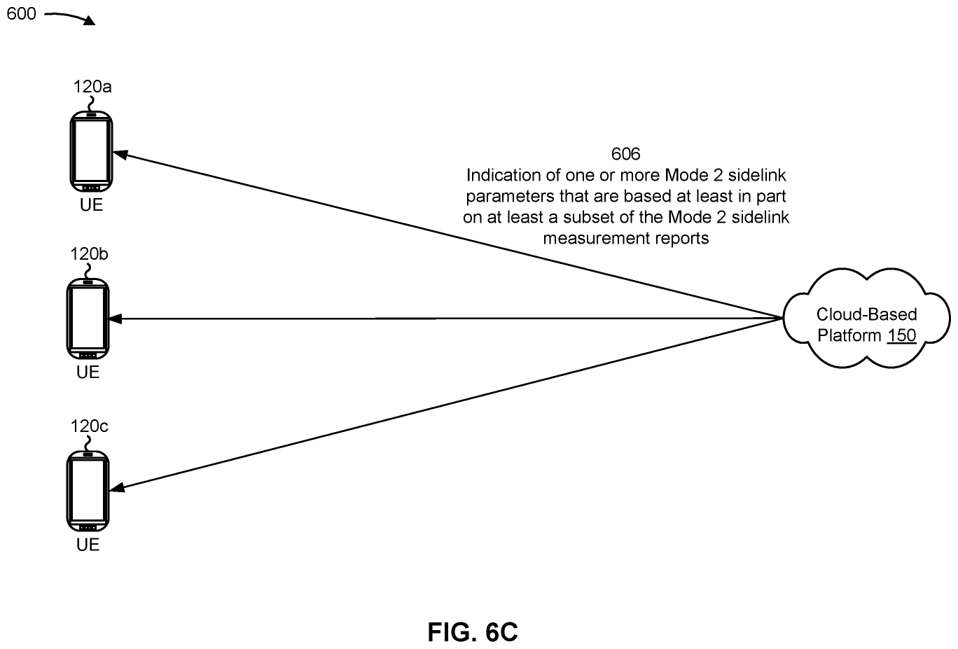

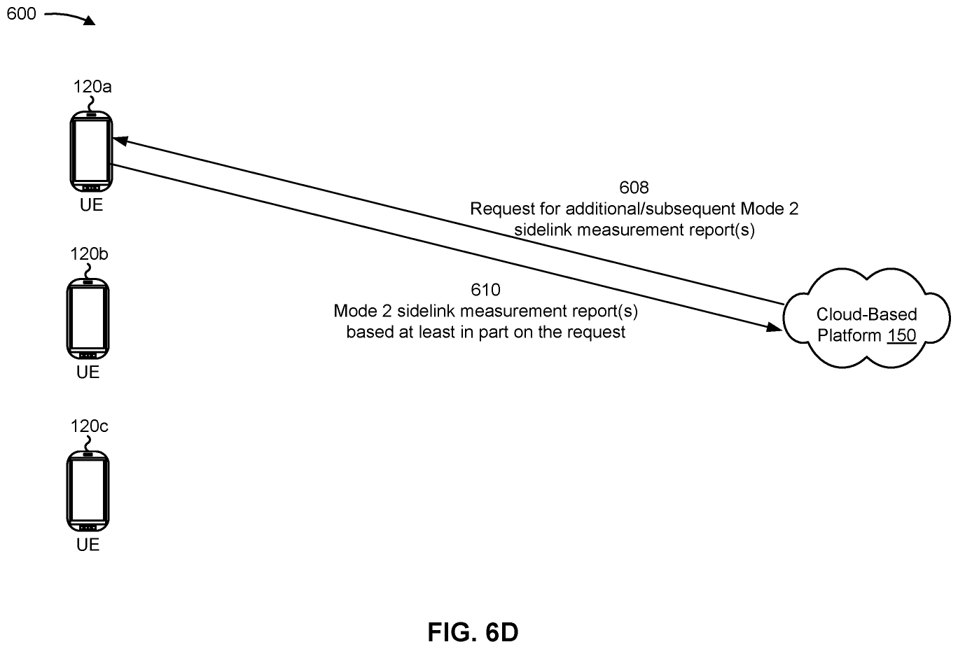

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-11).

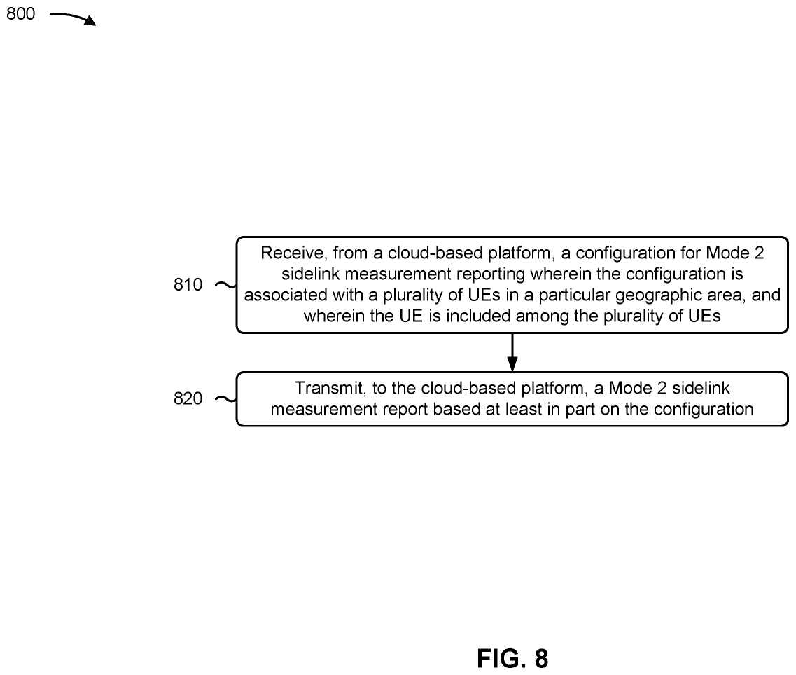

The controller/processor 240 of the base station 110, the controller/processor 280 of the UE 120, and/or any other component(s) of FIG. 2 may perform one or more techniques associated with UE-to-cloud reporting for Mode 2 sidelink parameter coordination, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, UE 120 may include means for receiving, from a cloud-based platform 150, a configuration for Mode 2 sidelink measurement reporting, wherein the configuration is associated with a plurality of UEs 120 in a particular geographic area, and wherein the UE 120 is included among the plurality of UEs 120: means for transmitting, to the cloud-based platform 150, a Mode 2 sidelink measurement report based at least in part on the configuration: or the like. In some aspects, such means may include one or more components of UE 120 described in connection with FIG. 2, such as controller/processor 280, transmit processor 264, TX MIMO processor 266, antenna 252, modem 254, MIMO detector 256, receive processor 258, the communication manager 140, or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

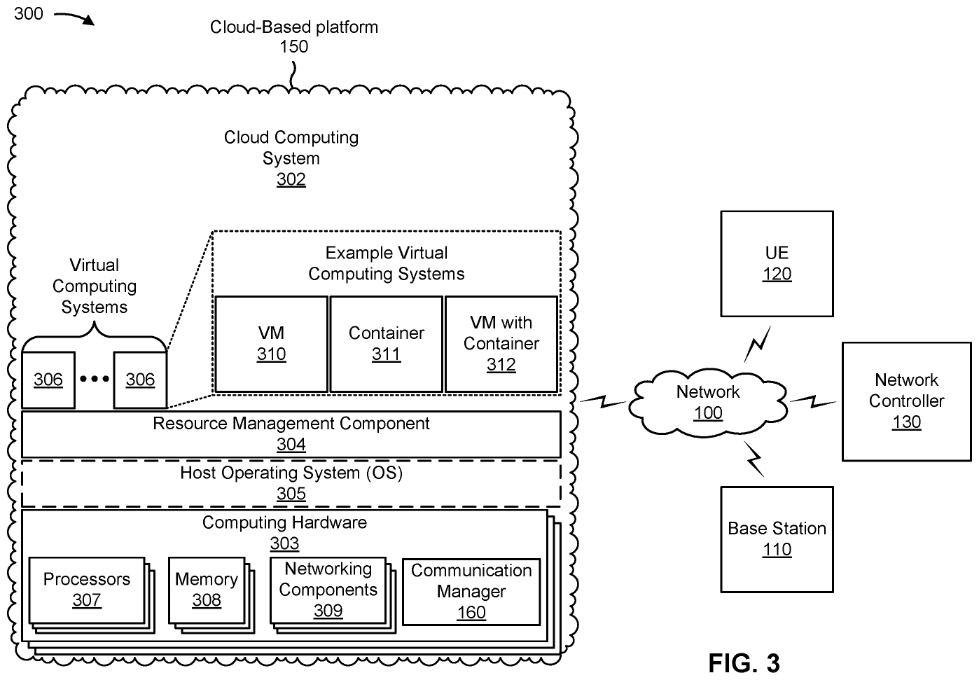

FIG. 3 is a diagram of an example environment 300, in accordance with the present disclosure. As shown in FIG. 3, environment 300 may include the cloud-based platform 150, which may include one or more elements of and/or may execute within a cloud computing system 302. The cloud computing system 302 may include one or more elements 303-312, as described in more detail below. As further shown in FIG. 3, environment 300 may include a wireless network 100, one or more base stations 110, one or more UEs 120, and/or one or more network controllers 130, among other examples. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein. Computing hardware 303 may also include the communication manager 160. Additionally and/or alternatively, the communication manager 160 may be implemented by one or more type of computing hardware 303, including one or more processors 307, one or more memories 308, and/or one or more networking components 309, among other examples.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the cloud-based platform 150 may include one or more elements 303-312 of the cloud computing system 302, may execute within the cloud computing system 302, and/or may be hosted within the cloud computing system 302, in some implementations, the cloud-based platform 150 may not be cloud-based (e.g., may be implemented outside of a cloud computing system) or may be partially cloud-based. For example, the cloud-based platform 150 may include one or more devices that are not part of the cloud computing system 302, such one or more network controllers 130, which may include a standalone server or another type of computing device. The cloud-based platform 150 may perform one or more operations and/or processes described in more detail elsewhere herein.

In some aspects, cloud-based platform 150 may include means for transmitting a configuration for Mode 2 sidelink measurement reporting to a plurality of UEs 120 in a particular geographic area, and/or means for receiving, from at least a subset of the plurality of UEs 120, Mode 2 sidelink measurement reports based at least in part on the configuration, among other examples. In some aspects, such means may include one or more components of the cloud-based platform 150 described in connection with FIG. 3, such as one or me processors 307, one or more memories 308, one or more networking components 309, the communication manager 160, or the like.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

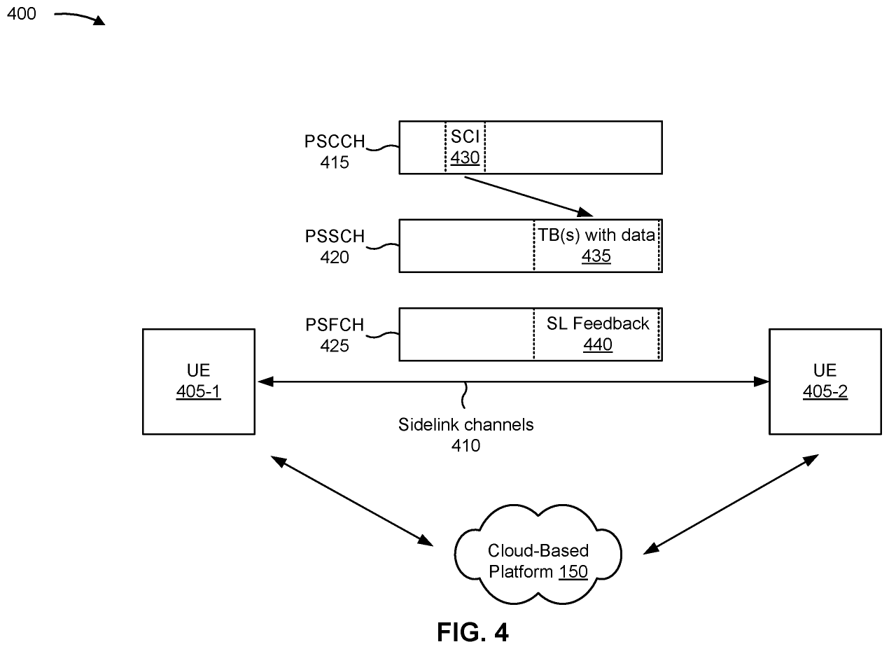

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing. In some aspects, one or more of the UEs 405-1 and/or 405-2 include an RSU. In some aspects, one or more of the UEs 405-1 and/or 405-2 communicate with a cloud-based platform such as the cloud-based platform 150.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 (or another type of network node) via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1 sidelink) where resource selection and/or scheduling is performed by a base station 110 or another type of network node. For example, the UE 405 may receive a grant (e.g., in downlink control information (DCI) or in a radio resource control (RRC) message, such as for configured grants) from the base station 110 for sidelink channel access and/or scheduling. In some aspects, a UE 405 may operate using a transmission mode (e.g., Mode 2 sidelink) where resource selection and/or scheduling is performed by the UE 405 (e.g., rather than a base station 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

In some aspects, one or more of the UEs 405-1 and/or 405-2 communicate with the cloud-based platform 150 to provide measurement information associated with one or more of the sidelink channels 410. The cloud-based platform 150 may determine, identify, and/or select parameters for communication on the one or more sidelink channels 410 for one or more of the UEs 405-1 and/or 405-2 to optimize Mode 2 resource selection and/or scheduling, as described herein.

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy rate (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

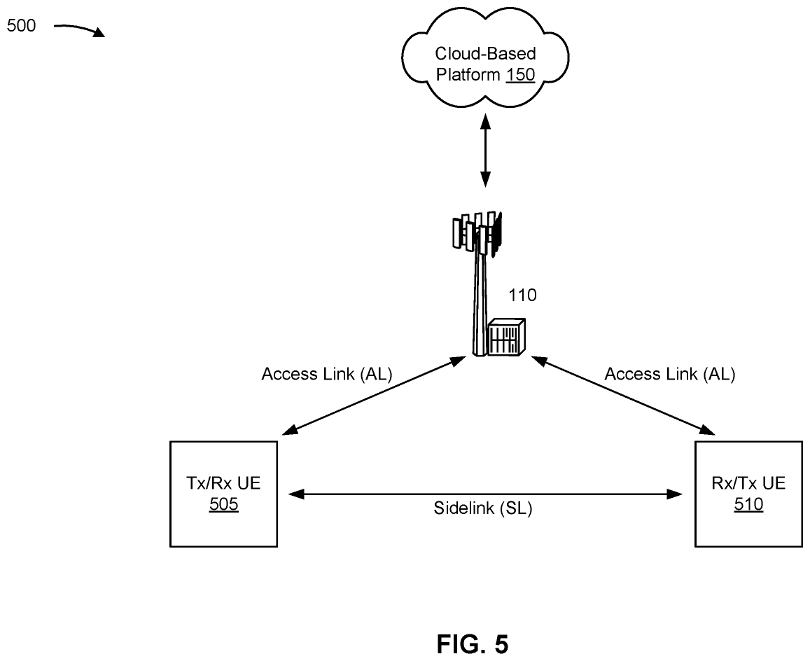

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a base station 110 (or another type of network node) may communicate with the Tx/Rx UE 505 via a first access link. Additionally, or alternatively, in some sidelink modes, the base station 110 may communicate with the Rx/Tx UE 510 via a second access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

In some aspects, one or more of the UEs 505 and/or 510 communicate with the cloud-based platform 150 to provide measurement information associated with the sidelink. The cloud-based platform 150 may determine, identify, and/or select parameters for communication on the sidelink for one or more of the UEs 505 and/or 510 to optimize Mode 2 resource selection and/or scheduling, as described herein.

As indicated above, FIG. 5 is provided as an example. Other examples may differ from what is described with respect to FIG. 5.

As described above, in Mode 2 sidelink, UEs may independently select and/or schedule resources for sidelink communication (e.g., autonomously by UEs without input from a base station). Such parameters include, for example, MCS, reference signal patterns (e.g., DMRS patterns), a quantity (e.g., a maximum quantity) of HARQ retransmissions, sidelink transmit power, negative acknowledgement (NACK) distance (e.g., in groupcast option 1), and/or a beta parameter, among other examples. In some cases, a UE may select default parameters or parameters that are dependent on a particular type of application. Additionally and/or alternatively, a UE may select parameters by on-the-fly measurements such as a CBR and/or another type of measurement.

While permitting a UE to independently select and/or schedule resources for sidelink communication may increase reliability and reduce latency for the UE, doing so can result in selfish selection of resources for sidelink communication which is detrimental to other UEs that communicate on a sidelink. Moreover, the UE may be unable to quickly adapt to environmental changes such as increased interference and/or sidelink congestion, which can occur where the UE is associated with a moving vehicle, for example.

Some aspects described herein provide UE-to-cloud reporting for Mode 2 sidelink parameter coordination. In some aspects, UEs (e.g., UEs 120) that are configured for Mode 2 resource section for sidelink communication may report sidelink measurements and/or parameters (and other types of measurements and/or parameters) to a centralized cloud-based platform. The cloud-based platform can collect data from the UEs and select optimal parameters (e.g., using machine-learning, artificial intelligence, and/or other advanced data processing and decision-making techniques) for the UEs. This enables the cloud-based platform to coordinate Mode 2 sidelink parameter selection for a plurality of UEs in a particular geographic area (e.g., which may experience similar sidelink and/or wireless network conditions). The cloud-based platform may provide Mode 2 sidelink parameter selection to the UEs as a service, and sidelink UEs may subscribe to the service to receive the benefits of Mode 2 sidelink parameter coordination from the cloud-based platform. In this way, the cloud-based platform may provide Mode 2 sidelink parameter coordination, which increases the efficiency of sidelink communications, reduces interference and collisions on the sidelink, and/or enables UEs 120 to quickly adapt to changing sidelink conditions.

FIGS. 6A-6D are diagrams illustrating examples 600 of UE-to-cloud reporting for Mode 2 sidelink parameter coordination, in accordance with the present disclosure. As shown in FIGS. 6A-6D, the examples 600 may include communication between a cloud-based platform 150 and a plurality of UEs 120 (e.g., UEs 120a-120c). The UEs 120 may be included in a wireless network such as wireless network 100. The quantities of UEs 120 shown in FIGS. 6A-6D is an example, and other quantities of UEs 120 are within the scope of the present disclosure.

The UEs 120 may be included in a particular geographic area. Generally, the particular geographic area may include a geographic area in which UEs 120 experience similar sidelink conditions, such as interference, congestion, and/or another sidelink condition. In some aspects, the particular geographic area may include a particular road or street. In some aspects, the particular geographic area may include a particular road segment (e.g., that is associated with an RSU or a base station 110 or another type of network node). In some aspects, the particular geographic area includes a particular portion of a city or an entire city or town. In some aspects, the particular geographic area includes a particular building or venue (e.g., a stadium). In some aspects, the particular geographic area includes a geographic area of a particular size (e.g., a particular radius, a particular parameter size).

The UEs 120 and the cloud-based platform 150 may communicate via the wireless network (e.g., via a sidelink of the wireless network, via an access link of the wireless network, or a combination thereof). In some aspects, one or more of the UEs 120 and the cloud-based platform may communicate via an RSU (e.g., a UE 120) of the wireless network, via a base station 110 (or another type of network node) of the wireless network, or a combination thereof.

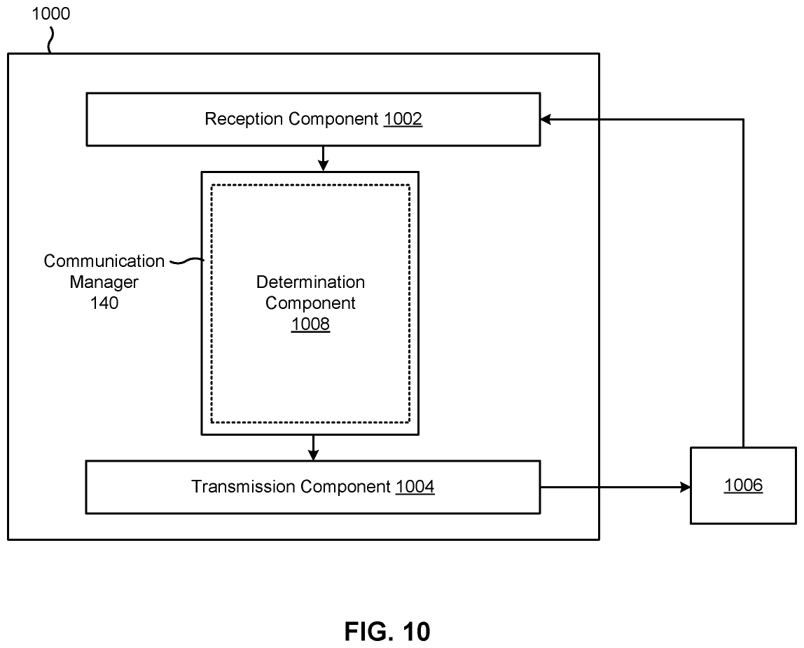

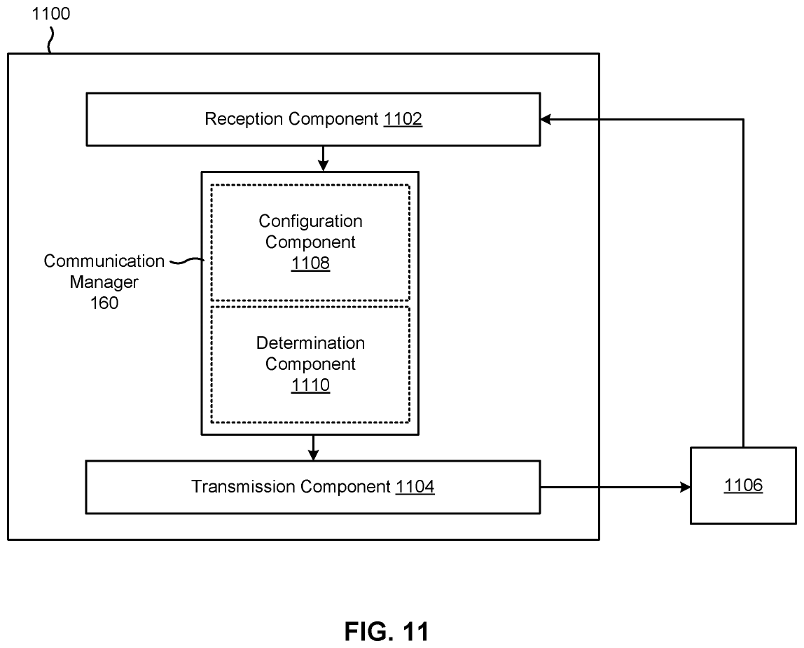

As shown in FIG. 6A, and by reference number 602, the cloud-based platform 150 may transmit (and the UEs 120 may receive) a configuration for Mode 2 sidelink reporting. The cloud-based platform 150 may transmit the configuration using a cloud computing system 302, computing hardware 303, one or more processors 307, one or more memories 308, one or more networking components 309, the communication manager 160, and/or a transmission component 1104 depicted in FIG. 11, among other examples. A UE 120 may receive the configuration using a receive processor 258, a controller/processor 280, the communication manager 140, and/or a reception component 1002 depicted in FIG. 10, among other examples. In some aspects, the cloud-based platform 150 transmits the configuration to the UEs 120 via a base station 110 (or another type of network node), via one or more RSUs, or a combination thereof.

In some aspects, the cloud-based platform 150 configures or generates (e.g., using a cloud computing system 302, computing hardware 303, one or more processors 307, one or more memories 308, one or more networking components 309, the communication manager 160, and/or a configuration component 1108 depicted in FIG. 11) the configuration based at least in part on one or more parameters associated with one or more of the UEs 120, such as one or more UE capabilities. The configuration may include one or more parameters for performing measurements, for reporting measurement results, and/or for reporting one or more parameters to support Mode 2 sidelink parameter coordination by the cloud-based platform 150.

For example, the configuration may indicate whether Mode 2 sidelink measurement reports are to be transmitted periodically (and the periodicity for periodically transmitting Mode 2 sidelink measurement reports), aperiodically (e.g., based at least in part on an event, such as where interference, congestion, or one or more other conditions on a sidelink satisfy an associated threshold, based at least in part on a request for a Mode 2 sidelink measurement report), or a combination thereof. As another example, the configuration may indicate one or more types of measurements for Mode 2 sidelink measurement reporting, one or more types of parameters that are to be reported to the UE 120, or a combination thereof. As another example, the configuration may indicate whether explicit values for the results of measurements are to be included for one or more measurement types, and/or whether qualitative indicators (e.g., high, low, medium) or range indicators are to be used for one or more measurement types.

As another example, the configuration may indicate whether the Mode 2 sidelink measurement reports are to be provided to the cloud-based platform 150 in dedicated PSSCH communications (e.g., PSSCH communications that are dedicated or specifically for Mode 2 sidelink measurement reporting) or piggybacked on PSSCH communications that also carry sidelink data. As another example, the configuration may indicate whether Mode 2 sidelink measurement reports for a particular UE 120 are to be multiplexed or aggregated into a single transmission to the cloud-based platform 150. As another example, the configuration may indicate whether Mode 2 sidelink measurement reports for a plurality of the UEs 120 are to be multiplexed or aggregated into a single transmission to the cloud-based platform 150.

In some aspects, the configuration includes a combination of the above-described parameters. In some aspects, the configuration includes one or more additional parameters not described above. In some aspects, the cloud-based platform 150 configures or generates configurations for each of the plurality of UEs 120. In some aspects, the cloud-based platform 150 configures or generates a common configuration for at least a subset of the UEs 120. Generally, configurations for the UEs 120 may include the same values for the one or more parameters, different values for the one or more parameters, different parameters, and/or a combination thereof.

As shown in FIG. 6B, and by reference number 604, at least a subset of the UEs 120 transmit (and the cloud-based platform 150 receives) Mode 2 sidelink measurement reports that are based at least in part on the configuration. In some aspects, one or more RSUs in the particular geographic area generate and transmit Mode 2 sidelink measurement reports that are based at least in part on the configuration. A UE 120 (or an RSU) may transmit a Mode 2 sidelink measurement report using a transmit processor 264, a controller/processor 280, the communication manager 140, and/or a transmission component 1004 depicted in FIG. 10, among other examples. The cloud-based platform 150 may receive Mode 2 sidelink measurement reports using a cloud computing system 302, computing hardware 303, one or more processors 307, one or more memories 308, one or more networking components 309, the communication manager 160, and/or a reception component 1002 depicted in FIG. 11, among other examples.

In some aspects, a UE 120 transmits a Mode 2 sidelink measurement report to the cloud-based platform 150 via an RSU, via a base station 110 (or another type of network node), or a combination thereof. The timing, periodicity, and/or content of the Mode 2 sidelink measurement reports may be based at least in part on the one or more parameters indicated in the configuration. Additionally and/or alternatively, one or more of the UEs 120 may be configured with one or more parameters for Mode 2 sidelink measurement reporting prior to deployment in the wireless network, and the one or more of the UE 120s may transmit Mode 2 sidelink measurement reports to the cloud-based platform 150 based at least in part on the one or more parameters for Mode 2 sidelink measurement reporting that were configured prior to deployment.

In some aspects, a UE 120 transmits Mode 2 sidelink measurement reports in a continual or persistent manner. For example, a UE 120 may transmit a plurality of Mode 2 sidelink measurement reports to provide updated measurement results to the cloud-based platform 150 so that the cloud-based platform 150 can continually coordinate Mode 2 sidelink parameter selection for the UEs 120.

In some aspects, a UE 120 transmits Mode 2 sidelink measurement reports at a particular periodicity based at least in part on an indication of the particular periodicity in the configuration. In some aspects, a UE 120 aperiodically transmits Mode 2 sidelink measurement reports. In some aspects, a UE 120 determines (e.g., using a controller/processor 280, the communication manager 140, and/or a determination component 1008 depicted in FIG. 10, among other examples) a time duration for transmitting Mode 2 sidelink measurement reports and transmits Mode 2 sidelink measurement reports to the cloud-based platform 150 based at least in part on the time duration. In these examples, the UE 120 may determine the time duration if the configuration indicates that the UE 120 is to periodically transmit Mode 2 sidelink measurement reports, or regardless of whether the configuration indicates that the UE 120 is to periodically transmit Mode 2 sidelink measurement reports.

In some aspects, a Mode 2 sidelink measurement report associated with a UE 120 may indicate results or metrics associated with one or more measurements performed by the UE 120. For example, the one or more measurements may include a sidelink transmit power measurement, a sidelink receive power measurement, and/or another sidelink measurement associated with the UE 120. In some aspects, a Mode 2 sidelink measurement report associated with a UE 120 may indicate one or more parameters associated with the UE 120, such as a quantity of sidelink packets that were transmitted by the UE 120 in a particular time duration, a quantity of sidelink packets that were decoded by the UE 120 in a particular time duration, a packet reception rate (PRR) performance (e.g., a quantity or percentage of received packets that were successfully decoded by the UE 120 in a particular time duration), whether the UE 120 supports one or more features or procedures, and/or another parameter.

In some aspects, a UE 120 includes explicit values for the results of measurements performed by the UE 120. In some aspects, the UE 120 includes a qualitative indicator for a result of a measurement or for a parameter (e.g., a “high” interference, a “low” quantity of transmitted packets). In some aspects, the UE 120 includes an indication of a range in which a result of a measurement or for a parameter (e.g., 10-30 decoded packets). Where a UE 120 transmits a plurality of Mode 2 sidelink measurement reports (e.g., periodically, based at least in part on a request or an event), the UE 120 may indicate changes or differences between the result of a measurement and a previous result of a measurement (e.g., a change in receive power).

In some aspects, a UE 120 transmits a Mode 2 sidelink measurement report in dedicated resources (e.g., time-domain resources, frequency-domain resources) for Mode 2 sidelink measurement reporting. In some aspects, a UE 120 transmits a Mode 2 sidelink measurement report in a PSSCH communication that is dedicated for Mode 2 sidelink measurement reporting. In these aspects, the use of a dedicated PSSCH communication may result in minimal changes to physical layer procedures, signals, and/or resources. Moreover, the use of a dedicated PSSCH communication may reduce the likelihood of congestion bursts and collisions and may reduce PSSCH transmission time. To further reduce the likelihood of congestion bursts and collisions, the configuration may indicate that the UE 120 is to transmit the Mode 2 sidelink measurement report in a reporting time window. The UE 120 may further indicate a probability of the Mode 2 sidelink measurement report, such as p<1, p=0.2, and/or another probability indicator.

In some aspects, a UE 120 transmits a Mode 2 sidelink measurement report in a PSSCH communication that is configured for transmitting sidelink data. In other words, the UE 120 “piggybacks” the Mode 2 sidelink measurement report on a PSSCH communication that also includes sidelink data. This minimizes PSSCH overhead (e.g., because fewer PSSCH communications are transmitted). The UE 120 may configured the PSSCH communication to indicate that the Mode 2 sidelink measurement report is directed to the cloud-based platform 150. In some aspects, if no PSSCH communication for sidelink data is scheduled, the UE 120 may refrain from transmitting a Mode 2 sidelink measurement report. However, the cloud-based platform 150 may separately trigger the UE 120 to provide the Mode 2 sidelink measurement report in these cases.

In some aspects, a UE 120 aggregates a plurality of Mode 2 sidelink measurement reports (or results of a plurality Mode 2 sidelink measurements) and multiplexes the Mode 2 sidelink measurement reports in a single transmission or communication to the cloud-based platform 150 to increase data efficiency. In these examples, the UE 120 ensures that the sensing intervals being reported (e.g., the times at which the UE 120 performed the plurality Mode 2 sidelink measurements) were observed or performed in the same geographic area. Otherwise, the UE 120 indicates which sets of Mode 2 sidelink measurement reports are associated with geographic areas.

In some aspects, a UE 120 transmits a plurality of Mode 2 sidelink measurement reports (or results of a plurality Mode 2 sidelink measurements) to an RSU, and the RSU aggregates and/or multiplexes the plurality of Mode 2 sidelink measurement reports from the same UE 120. The RSU transmits the aggregated and/or multiplexed Mode 2 sidelink measurement reports to the cloud-based platform 150. In some aspects, a plurality of UEs 120 transmit one or more Mode 2 sidelink measurement reports to an RSU, and the RSU aggregates and/or multiplexes the Mode 2 sidelink measurement reports for the plurality of UEs 120. The RSU transmits the aggregated and/or multiplexed Mode 2 sidelink measurement reports to the cloud-based platform 150.

As shown in FIG. 6C, and by reference number 606, the cloud-based platform 150 may transmit an indication of one or more Mode 2 sidelink parameters to the plurality of UEs 120. The cloud-based platform 150 may transmit the indication of one or more Mode 2 sidelink parameters using a cloud computing system 302, computing hardware 303, one or more processors 307, one or more memories 308, one or more networking components 309, the communication manager 160, and/or a transmission component 1104 depicted in FIG. 11, among other examples. A UE 120 may receive the indication of one or more Mode 2 sidelink parameters using a receive processor 258, a controller/processor 280, the communication manager 140, and/or a reception component 1002 depicted in FIG. 10, among other examples. In some aspects, the cloud-based platform 150 transmits the indication of one or more Mode 2 sidelink parameters to the UEs 120 via a base station 110 (or another type of network node), via one or more RSUs, or a combination thereof. The UEs 120 may receive the one or more Mode 2 sidelink parameters and may communicate on a sidelink based at least in part on the one or more Mode 2 sidelink parameters.

The cloud-based platform 150 may determine the one or more Mode 2 sidelink parameters based at least in part on the Mode 2 sidelink measurement reports received from one or more of the UEs 120. The cloud-based platform 150 may determine the one or more Mode 2 sidelink parameters using a cloud computing system 302, computing hardware 303, one or more processors 307, one or more memories 308, one or more networking components 309, the communication manager 160, and/or a determination component 1110 depicted in FIG. 11, among other examples. The cloud-based platform 150 may determine the one or more Mode 2 sidelink parameters to coordinate sidelink communication parameters for the UEs 120 in the particular geographic area to reduce interference and collisions, and to optimize sidelink communication in the particular geographic area.

The one or more Mode 2 sidelink parameters may include, for example, an MCS for use in the particular geographic area, a reference signal pattern (e.g., a DMRS pattern) for use in the particular geographic area, a quantity (e.g., a maximum quantity) of HARQ retransmissions permitted in the particular geographic area, a sidelink transmit power permitted in the particular geographic area, a NACK distance for use in the particular geographic area, and/or a beta parameter for use in the particular geographic area, among other examples.

In some aspects, the cloud-based platform 150 uses machine learning, artificial intelligence, and/or other advanced data processing techniques to determine the one or more Mode 2 sidelink parameters. In some implementations, the cloud-based platform 150 uses the machine learning model to determine the one or more Mode 2 sidelink parameters by providing candidate Mode 2 sidelink parameters as input to the machine learning model, and using the machine learning model to determine a likelihood, probability, or confidence that a particular outcome (e.g., a particular PRR performance) for a subsequent sidelink communication will be achieved in the particular geographic area using the candidate parameters. In some implementations, the cloud-based platform 150 provides a threshold PRR performance or another sidelink performance parameter threshold as input to the machine learning model, and the cloud-based platform 150 uses the machine learning model to determine or identify a particular combination of Mode 2 sidelink parameters that are likely to achieve the sidelink performance parameter threshold(s).

As shown in FIG. 6D, and by reference number 608, the cloud-based platform 150 may request additional/subsequent Mode 2 sidelink measurement report(s) from one or more of the UEs 120. UEs 120 (or associated vehicles) that are close to each other may have similar measurements to report. Accordingly, the cloud-based platform 150 may “sample” measurements from a subset of the UEs 120 by requesting additional/subsequent Mode 2 sidelink measurement report(s) from a subset of the UEs 120. The cloud-based platform 150 may transmit a request for additional/subsequent Mode 2 sidelink measurement report(s) using a cloud computing system 302, computing hardware 303, one or more processors 307, one or more memories 308, one or more networking components 309, the communication manager 160, and/or a transmission component 1104 depicted in FIG. 11, among other examples. A UE 120 may receive the request using a receive processor 258, a controller/processor 280, the communication manager 140, and/or a reception component 1002 depicted in FIG. 10, among other examples. In some aspects, the cloud-based platform 150 transmits the request to a UE 120 via a base station 110 (or another type of network node), via one or more RSUs, or a combination thereof.

As further shown in FIG. 6D, and by reference number 610, the UE 120 may transmit additional/subsequent Mode 2 sidelink measurement report(s) to the cloud-based platform 150 based at least in part on the request. The cloud-based platform 150 may use the additional/subsequent Mode 2 sidelink measurement report(s) to update Mode 2 sidelink parameters in the particular geographic area for Mode 2 sidelink parameter coordination. The UE 120 may transmit the additional/subsequent Mode 2 sidelink measurement report(s) using a transmit processor 264, a controller/processor 280, the communication manager 140, and/or a transmission component 1004 depicted in FIG. 10, among other examples. The cloud-based platform 150 may receive the additional/subsequent Mode 2 sidelink measurement report(s) using a cloud computing system 302, computing hardware 303, one or more processors 307, one or more memories 308, one or more networking components 309, the communication manager 160, and/or a reception component 1002 depicted in FIG. 11, among other examples. In some aspects, the UE 120 transmits the additional/subsequent Mode 2 sidelink measurement report(s) to the cloud-based platform 150 via an RSU, via a base station 110 (or another type of network node), or a combination thereof.

As indicated above, FIGS. 6A-6D are provided as examples. Other examples may differ from what is described with respect to FIGS. 6A-6D.

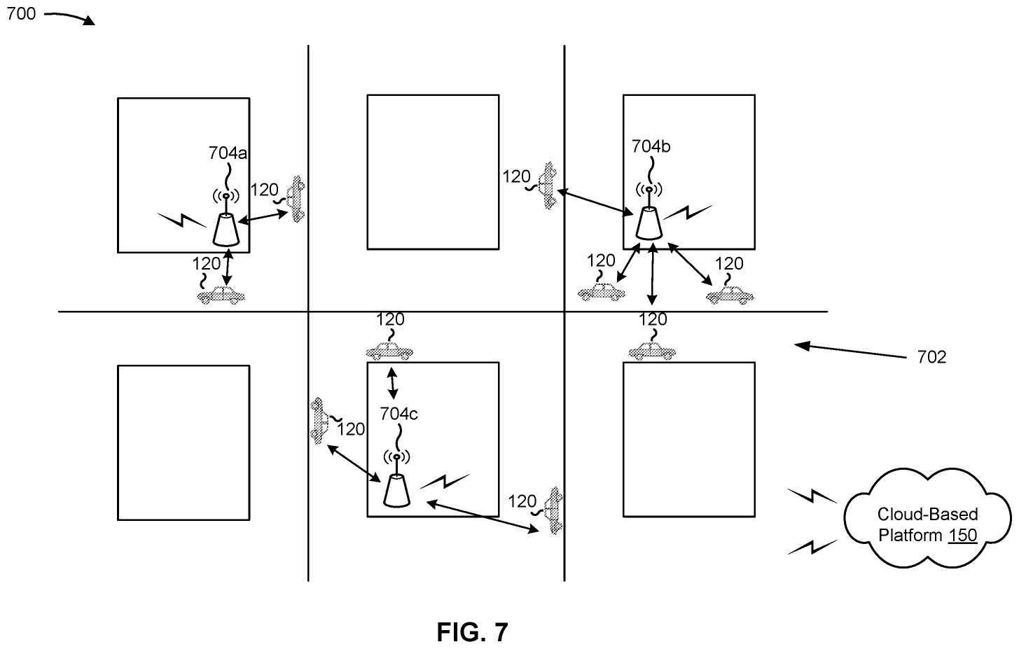

FIG. 7 is a diagram illustrating an example 700 of UE-to-cloud reporting for Mode 2 sidelink parameter coordination, in accordance with the present disclosure. As shown in FIG. 7, a plurality of UEs 120 may be associated with vehicles that travel along one or more roads 702. Additionally and/or alternatively, at least a subset of the UEs 120 may be associated with pedestrians that travel along the one or more roads 702 and/or other types of non-vehicle users.

As further shown in FIG. 7, the UEs 120 may communicate with one or more RSUs 704a-704c. The quantities of UEs, RSUs, and cloud-based platforms illustrated in FIG. 7 is an example, and other quantities are within the scope of the present disclosure.

An RSU includes a UE (e.g., a stationary UE) that communicates with UEs 120 on a sidelink, and with the cloud-based platform 150 via a base station 110 (or another type of network node) on an access link. For example, an RSU may receive a sidelink communication from a UE 120 on a sidelink, and the RSU may transmit data and/or information of the sidelink communication to the cloud-based platform 150 in an uplink communication on an access link via a base station 110 (or another type of network node). As another example, the RSU may receive a downlink communication from the cloud-based platform 150 via a base station 110 (or another type of network node) on an access link, and the RSU may transmit data and/or information of the sidelink communication to a UE 120 in a sidelink communication on a sidelink.

In some aspects, each RSU is associated with a particular geographic area, and communicates with the UEs 120 in the particular geographic area. For example, the RSU 704a may be associated with a particular block or segment of the one or more roads 702, and the RSU 704a may communicate with the UEs 120 in the particular block or section of the one or more roads 702. RSUs 704b and 704c may be associated with similarly (or differently) configured geographic areas. In some aspects, an RSU is associated with a geographic area of a particular size (e.g., a particular radius, a particular amount of area).

As described above in connection with FIGS. 6A-6D, the cloud-based platform 150 may transmit a configuration for Mode 2 sidelink measurement reporting to a plurality of UEs 120 in a particular geographic area. For example, the cloud-based platform 150 may transmit a configuration for Mode 2 sidelink measurement reporting to the UEs 120 associated with the RSU 704b. The UEs 120 in the particular geographic area may receive the configuration and may transmit one or more Mode 2 sidelink measurement reports (e.g., periodically, based at least in part on request) to the cloud-based platform 150 via the RSU 704b based at least in part on the configuration. Additionally and/or alternatively, the cloud-based platform 150 may transmit a configuration for Mode 2 sidelink measurement reporting to the RSU 704b, and the RSU 704b may transmit one or more Mode 2 sidelink measurement reports to the cloud-based platform 150 based at least in part on the configuration.

As described above in connection with FIGS. 6A-6D, the cloud-based platform 150 may receive the Mode 2 sidelink measurement reports and may transmit one or more Mode 2 sidelink parameters to the UEs 120 via the RSU 704b. The one or more Mode 2 sidelink parameters may be based at least in part on at least a subset of the Mode 2 sidelink measurement reports. In particular, the cloud-based platform 150 may determine the one or more Mode 2 sidelink parameters for the UEs 120 to coordinate sidelink communication in the particular geographic area.

As an example of the above, the cloud-based platform 150 may determine that a UE 120 in a first (congested) geographic area is traveling out of the first geographic area and into a second (less congested) geographic area. The PRR performance in the first geographic area may be increased by reducing the NACK distance for the UE 120, as PRR may be sensitive to NACK distance in congested areas. The PRR performance in the second geographic area is increased due to less congestion. Accordingly, the cloud-based platform 150 may optimize the NACK distance for the UE 120 in the second (less congested) geographic area by providing a Mode 2 sidelink parameter for the UE 120 to increase the NACK distance for the UE 120.

While the example in FIG. 7 illustrates a single cloud-based platform 150 for the RSUs 704a-704c, in some aspects, each RSU (or each particular geographic area) may be associated with a respective cloud-based platform 150 that is configured to coordinate Mode 2 sidelink parameter selection for the associated RSU (or for the associated particular geographic area).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with UE-to-cloud reporting for Mode 2 sidelink parameter coordination.

As shown in FIG. 8, in some aspects, process 800 may include receiving, from a cloud-based platform, a configuration for Mode 2 sidelink measurement reporting, wherein the configuration is associated with a plurality of UEs in a particular geographic area, and wherein the UE is included among the plurality of UEs (block 810). For example, the UE (e.g., using communication manager 140 and/or reception component 1002, depicted in FIG. 10) may receive, from a cloud-based platform, a configuration for Mode 2 sidelink measurement reporting, wherein the configuration is associated with a plurality of UEs in a particular geographic area, and wherein the UE is included among the plurality of UEs, as described above. In some aspects, the configuration is associated with a plurality of UEs in a particular geographic area. In some aspects, the UE is included among the plurality of UEs.

As further shown in FIG. 8, in some aspects, process 800 may include transmitting, to the cloud-based platform, a Mode 2 sidelink measurement report based at least in part on the configuration (block 820). For example, the UE (e.g., using communication manager 140 and/or transmission component 1004, depicted in FIG. 10) may transmit, to the cloud-based platform, a Mode 2 sidelink measurement report based at least in part on the configuration, as described above.

Process 800 may include additional aspects, such as any single aspect or any combination of aspects described below and/or in connection with one or more other processes described elsewhere herein.

In a first aspect, the Mode 2 sidelink measurement report indicates at least one of results of one or more measurements, or one or more parameters associated with the UE, wherein the one or more measurements include at least one of a sidelink transmit power measurement, or a sidelink receive power measurement, and wherein the one or more parameters associated with the UE include at least one of a quantity of packets transmitted by the UE in a particular time duration, or a quantity of packets decoded by the UE in a particular time duration.

In a second aspect, alone or in combination with the first aspect, the Mode 2 sidelink measurement report includes explicit values for at least one of the results of the one or more measurements or the one or more parameters associated with the UE.

In a third aspect, alone or in combination with one or more of the first and second aspects, the Mode 2 sidelink measurement report includes a qualitative indicator for at least one of the results of the one or more measurements or the one or more parameters associated with the UE.

In a fourth aspect, alone or in combination with one or more of the first through third aspects, the Mode 2 sidelink measurement report indicates a difference between a result and a previous result of a measurement of the one or more measurements.

In a fifth aspect, alone or in combination with one or more of the first through fourth aspects, process 800 includes receiving, from the cloud-based platform, a request for another Mode 2 sidelink measurement report, and transmitting, to the cloud-based platform, the other Mode 2 sidelink measurement report based at least in part on receiving the request.

In a sixth aspect, alone or in combination with one or more of the first through fifth aspects, process 800 includes transmitting, to the cloud-based platform, additional Mode 2 sidelink measurement reports at a particular periodicity based at least in part on an indication of the particular periodicity in the configuration.

In a seventh aspect, alone or in combination with one or more of the first through sixth aspects, process 800 includes determining a time duration for transmitting a subsequent Mode 2 sidelink measurement report, and transmitting, to the cloud-based platform, the subsequent Mode 2 sidelink measurement report based at least in part on the time duration.

In an eighth aspect, alone or in combination with one or more of the first through seventh aspects, process 800 includes receiving, from the cloud-based platform, an indication of one or more Mode 2 sidelink parameters that are based at least in part on at least one of the Mode 2 sidelink measurement report, or other Mode 2 sidelink measurement reports associated with one or more other UEs of the plurality of UEs, and communicating on a sidelink based at least in part on the one or more Mode 2 sidelink parameters.

In a ninth aspect, alone or in combination with one or more of the first through eighth aspects, transmitting the Mode 2 sidelink measurement report comprises transmitting, during a reporting time window, the Mode 2 sidelink measurement report in a PSSCH communication that is dedicated for Mode 2 sidelink measurement reporting.

In a tenth aspect, alone or in combination with one or more of the first through ninth aspects, transmitting the Mode 2 sidelink measurement report comprises transmitting the Mode 2 sidelink measurement report in a PSSCH communication that is configured for transmitting sidelink data, wherein the PSSCH communication indicates that the Mode 2 sidelink measurement report is directed to the cloud-based platform.

In an eleventh aspect, alone or in combination with one or more of the first through tenth aspects, the configuration indicates whether to transmit the Mode 2 sidelink measurement report in a dedicated PSSCH communication or in a PSSCH communication that is configured for transmitting sidelink data.

In a twelfth aspect, alone or in combination with one or more of the first through eleventh aspects, transmitting the Mode 2 sidelink measurement report comprises transmitting the Mode 2 sidelink measurement report in a sidelink communication in which the Mode 2 sidelink measurement report is multiplexed with at least one of one or more other Mode 2 sidelink measurement reports that were generated for the particular geographic area, or one or more other Mode 2 sidelink measurement reports that were generated for another geographic area.

In a thirteenth aspect, alone or in combination with one or more of the first through twelfth aspects, transmitting the Mode 2 sidelink measurement report comprises transmitting the Mode 2 sidelink measurement report on a sidelink to an RSU for aggregation of the Mode 2 sidelink measurement report with one or more other Mode 2 sidelink measurement reports associated with at least a subset of the plurality of UEs.

In a fourteenth aspect, alone or in combination with one or more of the first through thirteenth aspects, the UE comprises a RSU, or wherein the UE is associated with a vehicle.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a cloud-based platform, in accordance with the present disclosure. Example process 900 is an example where the cloud-based platform (e.g., cloud-based platform 150) performs operations associated with UE-to-cloud reporting for Mode 2 sidelink parameter coordination.

As shown in FIG. 9, in some aspects, process 900 may include transmitting a configuration for Mode 2 sidelink measurement reporting to a plurality of UEs in a particular geographic area (block 910). For example, the cloud-based platform (e.g., using communication manager 160 and/or transmission component 1104, depicted in FIG. 11) may transmit a configuration for Mode 2 sidelink measurement reporting to a plurality of UEs in a particular geographic area, as described above.

As further shown in FIG. 9, in some aspects, process 900 may include receiving, from at least a subset of the plurality of UEs, Mode 2 sidelink measurement reports based at least in part on the configuration (block 920). For example, the cloud-based platform (e.g., using communication manager 160 and/or reception component 1102, depicted in FIG. 11) may receive, from at least a subset of the plurality of UEs, Mode 2 sidelink measurement reports based at least in part on the configuration, as described above.

Process 900 may include additional aspects, such as any single aspect or any combination of aspects described below and/or in connection with one or more other processes described elsewhere herein.

In a first aspect, process 900 includes transmitting, to a UE of the plurality of UEs, a request for another Mode 2 sidelink measurement report, and receiving, from the UE, the other Mode 2 sidelink measurement report.

In a second aspect, alone or in combination with the first aspect, process 900 includes receiving, from a UE of the plurality of UEs, additional Mode 2 sidelink measurement reports at a particular periodicity based at least in part on an indication of the particular periodicity in the configuration.

In a third aspect, alone or in combination with one or more of the first and second aspects, process 900 includes transmitting, to the plurality of UEs, an indication of one or more Mode 2 sidelink parameters that are based at least in part on at least a subset of the Mode 2 sidelink measurement reports.

In a fourth aspect, alone or in combination with one or more of the first through third aspects, receiving the Mode 2 sidelink measurement reports comprises receiving, from a UE of the plurality of UEs and during a reporting time window, a Mode 2 sidelink measurement report of the Mode 2 sidelink measurement reports in a PSSCH communication that is dedicated for Mode 2 sidelink measurement reporting.

In a fifth aspect, alone or in combination with one or more of the first through fourth aspects, receiving the Mode 2 sidelink measurement reports comprises receiving, from a UE of the plurality of UEs, a Mode 2 sidelink measurement report of the Mode 2 sidelink measurement reports in a PSSCH communication that is configured for transmitting sidelink data, wherein the PSSCH communication indicates that the Mode 2 sidelink measurement report is directed to the cloud-based platform.

In a sixth aspect, alone or in combination with one or more of the first through fifth aspects, the configuration indicates whether to transmit the Mode 2 sidelink measurement reports in dedicated PSSCH communications or in PSSCH communications that are configured for transmitting sidelink data.

In a seventh aspect, alone or in combination with one or more of the first through sixth aspects, receiving the Mode 2 sidelink measurement report comprises receiving, from a UE of the plurality of UEs, a Mode 2 sidelink measurement report of the Mode 2 sidelink measurement reports in a sidelink communication in which the Mode 2 sidelink measurement report is multiplexed with at least one of one or more other Mode 2 sidelink measurement reports that were generated for the particular geographic area, or one or more other Mode 2 sidelink measurement reports that were generated for another geographic area.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a determination component 1008, among other examples.

In some aspects, the apparatus 1000 may be configured to perform one or more operations described herein in connection with FIGS. 6A-6D and/or 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from an apparatus 1006, a configuration for Mode 2 sidelink measurement reporting, wherein the configuration is associated with a plurality of apparatuses 1000 in a particular geographic area, and wherein the apparatus 1000 is included among the plurality of apparatuses 1000. The transmission component 1004 may transmit, to the apparatus 1006, a Mode 2 sidelink measurement report based at least in part on the configuration.

The reception component 1002 may receive, from the apparatus 1006, a request for another Mode 2 sidelink measurement report. The transmission component 1004 may transmit, to the apparatus 1006, the other Mode 2 sidelink measurement report based at least in part on receiving the request. The transmission component 1004 may transmit, to the apparatus 1006, additional Mode 2 sidelink measurement reports at a particular periodicity based at least in part on an indication of the particular periodicity in the configuration.

The determination component 1008 may determine a time duration for transmitting a subsequent Mode 2 sidelink measurement report. The transmission component 1004 may transmit, to the apparatus 1006, the subsequent Mode 2 sidelink measurement report based at least in part on the time duration.

The reception component 1002 may receive, from the apparatus 1006, an indication of one or more Mode 2 sidelink parameters that are based at least in part on at least one of the Mode 2 sidelink measurement report, or other Mode 2 sidelink measurement reports associated with one or more other apparatuses 1000 of the plurality of apparatuses 1000.

The reception component 1002 and/or the transmission component 1004 may communicate on a sidelink based at least in part on the one or more Mode 2 sidelink parameters.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a cloud-based platform (e.g., a cloud-based platform 150), or a cloud-based platform may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 160. The communication manager 160 may include one or more of a configuration component 1108 or a determination component 1110, among other examples.

In some aspects, the apparatus 1100 may be configured to perform one or more operations described herein in connection with FIGS. 6A-6D and/or 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the cloud-based platform described in connection with FIG. 3. Additionally, or alternatively, one or more components shown in FIG. 11 may be implemented within one or more components described in connection with FIG. 3. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the cloud-based platform described in connection with FIG. 3.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the cloud-based platform described in connection with FIG. 3. In some aspects, the transmission component 1104 may be co-located with the reception component 1102 in a transceiver.

The transmission component 1104 may transmit a configuration for Mode 2 sidelink measurement reporting to a plurality of apparatuses 1106 in a particular geographic area. In some aspects, the configuration component 1108 generates the configuration. The reception component 1102 may receive, from at least a subset of the plurality of apparatuses 1106, Mode 2 sidelink measurement reports based at least in part on the configuration.

In some aspects, the transmission component 1104 may transmit, to an apparatus 1106 of the plurality of apparatuses 1106, a request for another Mode 2 sidelink measurement report. The reception component 1102 may receive, from the apparatus 1106, the other Mode 2 sidelink measurement report. In some aspects, the reception component 1102 may receive, from an apparatus 1106 of the plurality of apparatuses 1106, additional Mode 2 sidelink measurement reports at a particular periodicity based at least in part on an indication of the particular periodicity in the configuration.

In some aspects, the transmission component 1104 may transmit, to the plurality of apparatuses 1106, an indication of one or more Mode 2 sidelink parameters that are based at least in part on at least a subset of the Mode 2 sidelink measurement reports. In some aspects, the determination component 1110 may determine the one or more Mode 2 sidelink parameters based at least in part on the at least the subset of the Mode 2 sidelink measurement reports.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a cloud-based platform, a configuration for Mode 2 sidelink measurement reporting, wherein the configuration is associated with a plurality of UEs in a particular geographic area, and wherein the UE is included among the plurality of UEs; and transmitting, to the cloud-based platform, a Mode 2 sidelink measurement report based at least in part on the configuration.

Aspect 2: The method of Aspect 1, wherein the Mode 2 sidelink measurement report indicates at least one of: results of one or more measurements, or one or more parameters associated with the UE, wherein the one or more measurements include at least one of: a sidelink transmit power measurement, or a sidelink receive power measurement; and wherein the one or more parameters associated with the UE include at least one of: a quantity of packets transmitted by the UE in a particular time duration, or a quantity of packets decoded by the UE in a particular time duration.

Aspect 3: The method of Aspect 2, wherein the Mode 2 sidelink measurement report includes explicit values for at least one of the results of the one or more measurements or the one or more parameters associated with the UE.

Aspect 4: The method of Aspect 2 or 3, wherein the Mode 2 sidelink measurement report includes a qualitative indicator for at least one of the results of the one or more measurements or the one or more parameters associated with the UE.

Aspect 5: The method of one or more of Aspects 2-4, wherein the Mode 2 sidelink measurement report indicates a difference between a result and a previous result of a measurement of the one or more measurements.

Aspect 6: The method of one or more of Aspects 1-5, further comprising: receiving, from the cloud-based platform, a request for another Mode 2 sidelink measurement report; and transmitting, to the cloud-based platform, the other Mode 2 sidelink measurement report based at least in part on receiving the request.

Aspect 7: The method of one or more of Aspects 1-6, further comprising:

transmitting, to the cloud-based platform, additional Mode 2 sidelink measurement reports at a particular periodicity based at least in part on an indication of the particular periodicity in the configuration.

Aspect 8: The method of one or more of Aspects 1-7, further comprising: determining a time duration for transmitting a subsequent Mode 2 sidelink measurement report; and transmitting, to the cloud-based platform, the subsequent Mode 2 sidelink measurement report based at least in part on the time duration.

Aspect 9: The method of one or more of Aspects 1-8, further comprising: receiving, from the cloud-based platform, an indication of one or more Mode 2 sidelink parameters that are based at least in part on at least one of: the Mode 2 sidelink measurement report, or other Mode 2 sidelink measurement reports associated with one or more other UEs of the plurality of UEs; and communicating on a sidelink based at least in part on the one or more Mode 2 sidelink parameters.

Aspect 10: The method of one or more of Aspects 1-9, wherein transmitting the Mode 2 sidelink measurement report comprises: transmitting, during a reporting time window, the Mode 2 sidelink measurement report in a physical sidelink shared channel (PSSCH) communication that is dedicated for Mode 2 sidelink measurement reporting.

Aspect 11: The method of one or more of Aspects 1-10, wherein transmitting the Mode 2 sidelink measurement report comprises: transmitting the Mode 2 sidelink measurement report in a physical sidelink shared channel (PSSCH) communication that is configured for transmitting sidelink data, wherein the PSSCH communication indicates that the Mode 2 sidelink measurement report is directed to the cloud-based platform.

Aspect 12: The method of one or more of Aspects 1-11, wherein the configuration indicates whether to transmit the Mode 2 sidelink measurement report in a dedicated physical sidelink shared channel (PSSCH) communication or in a PSSCH communication that is configured for transmitting sidelink data.

Aspect 13: The method of one or more of Aspects 1-12, wherein transmitting the Mode 2 sidelink measurement report comprises: transmitting the Mode 2 sidelink measurement report in a sidelink communication in which the Mode 2 sidelink measurement report is multiplexed with at least one of: one or more other Mode 2 sidelink measurement reports that were generated for the particular geographic area, or one or more other Mode 2 sidelink measurement reports that were generated for another geographic area.

Aspect 14: The method of one or more of Aspects 1-13, wherein transmitting the Mode 2 sidelink measurement report comprises: transmitting the Mode 2 sidelink measurement report on a sidelink to a roadside unit (RSU) for aggregation of the Mode 2 sidelink measurement report with one or more other Mode 2 sidelink measurement reports associated with at least a subset of the plurality of UEs.

Aspect 15: The method of one or more of Aspects 1-14, wherein the UE comprises a roadside unit (RSU), or wherein the UE is associated with a vehicle.

Aspect 16: A method of wireless communication performed by a cloud-based platform, comprising: transmitting a configuration for Mode 2 sidelink measurement reporting to a plurality of user equipments (UEs) in a particular geographic area; and receiving, from at least a subset of the plurality of UEs, Mode 2 sidelink measurement reports based at least in part on the configuration.

Aspect 17: The method of Aspect 16, further comprising: transmitting, to a UE of the plurality of UEs, a request for another Mode 2 sidelink measurement report; and receiving, from the UE, the other Mode 2 sidelink measurement report.

Aspect 18: The method of Aspect 16 or 17, further comprising: receiving, from a UE of the plurality of UEs, additional Mode 2 sidelink measurement reports at a particular periodicity based at least in part on an indication of the particular periodicity in the configuration.

Aspect 19: The method of one or more of Aspects 16-18, further comprising: transmitting, to the plurality of UEs, an indication of one or more Mode 2 sidelink parameters that are based at least in part on at least a subset of the Mode 2 sidelink measurement reports.

Aspect 20: The method of one or more of Aspects 16-19, wherein receiving the Mode 2 sidelink measurement reports comprises: receiving, from a UE of the plurality of UEs and during a reporting time window, a Mode 2 sidelink measurement report of the Mode 2 sidelink measurement reports in a physical sidelink shared channel (PSSCH) communication that is dedicated for Mode 2 sidelink measurement reporting.

Aspect 21: The method of one or more of Aspects 16-20, wherein receiving the Mode 2 sidelink measurement reports comprises: receiving, from a UE of the plurality of UEs, a Mode 2 sidelink measurement report of the Mode 2 sidelink measurement reports in a physical sidelink shared channel (PSSCH) communication that is configured for transmitting sidelink data, wherein the PSSCH communication indicates that the Mode 2 sidelink measurement report is directed to the cloud-based platform.

Aspect 22: The method of one or more of Aspects 16-21, wherein the configuration indicates whether to transmit the Mode 2 sidelink measurement reports in dedicated physical sidelink shared channel (PSSCH) communications or in PSSCH communications that are configured for transmitting sidelink data.

Aspect 23: The method of one or more of Aspects 16-22, wherein receiving the Mode 2 sidelink measurement report comprises: receiving, from a UE of the plurality of UEs, a Mode 2 sidelink measurement report of the Mode 2 sidelink measurement reports in a sidelink communication in which the Mode 2 sidelink measurement report is multiplexed with at least one of: one or more other Mode 2 sidelink measurement reports that were generated for the particular geographic area, or one or more other Mode 2 sidelink measurement reports that were generated for another geographic area.

Aspect 24: An apparatus for wireless communication at a device, comprising a processor: memory coupled with the processor; and instructions stored in the memory and executable by the processor to cause the apparatus to perform the method of one or more of Aspects 1-15.

Aspect 25: A device for wireless communication, comprising a memory and one or more processors coupled to the memory, the one or more processors configured to perform the method of one or more of Aspects 1-15.

Aspect 26: An apparatus for wireless communication, comprising at least one means for performing the method of one or more of Aspects 1-15.

Aspect 27: A non-transitory computer-readable medium storing code for wireless communication, the code comprising instructions executable by a processor to perform the method of one or more of Aspects 1-15.

Aspect 28: A non-transitory computer-readable medium storing a set of instructions for wireless communication, the set of instructions comprising one or more instructions that, when executed by one or more processors of a device, cause the device to perform the method of one or more of Aspects 1-15.

Aspect 29: An apparatus for wireless communication at a device, comprising a processor: memory coupled with the processor; and instructions stored in the memory and executable by the processor to cause the apparatus to perform the method of one or more of Aspects 16-23.

Aspect 30: A device for wireless communication, comprising a memory and one or more processors coupled to the memory, the one or more processors configured to perform the method of one or more of Aspects 16-23.

Aspect 31: An apparatus for wireless communication, comprising at least one means for performing the method of one or more of Aspects 16-23.

Aspect 32: A non-transitory computer-readable medium storing code for wireless communication, the code comprising instructions executable by a processor to perform the method of one or more of Aspects 16-23.

Aspect 33: A non-transitory computer-readable medium storing a set of instructions for wireless communication, the set of instructions comprising one or more instructions that, when executed by one or more processors of a device, cause the device to perform the method of one or more of Aspects 16-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a cloud-based platform, a configuration for Mode 2 sidelink measurement reporting,
wherein the configuration is associated with a plurality of UEs in a particular geographic area, and
wherein the UE is included among the plurality of UEs; and
transmitting, to the cloud-based platform, a Mode 2 sidelink measurement report based at least in part on the configuration.

2. The method of claim 1, wherein the Mode 2 sidelink measurement report indicates at least one of:
results of one or more measurements, or
one or more parameters associated with the UE,
wherein the one or more measurements include at least one of:
a sidelink transmit power measurement, or
a sidelink receive power measurement; and
wherein the one or more parameters associated with the UE include at least one of:
a quantity of packets transmitted by the UE in a particular time duration, or
a quantity of packets decoded by the UE in a particular time duration.

3. The method of claim 2, wherein the Mode 2 sidelink measurement report includes explicit values for at least one of the results of the one or more measurements or the one or more parameters associated with the UE.

4. The method of claim 2, wherein the Mode 2 sidelink measurement report includes a qualitative indicator for at least one of the results of the one or more measurements or the one or more parameters associated with the UE.

5. The method of claim 2, wherein the Mode 2 sidelink measurement report indicates a difference between a result and a previous result of a measurement of the one or more measurements.

6. The method of claim 1, further comprising:
receiving, from the cloud-based platform, a request for another Mode 2 sidelink measurement report; and
transmitting, to the cloud-based platform, the other Mode 2 sidelink measurement report based at least in part on receiving the request.

7. The method of claim 1, further comprising:
transmitting, to the cloud-based platform, additional Mode 2 sidelink measurement reports at a particular periodicity based at least in part on an indication of the particular periodicity in the configuration.

8. The method of claim 1, further comprising:
determining a time duration for transmitting a subsequent Mode 2 sidelink measurement report; and
transmitting, to the cloud-based platform, the subsequent Mode 2 sidelink measurement report based at least in part on the time duration.

9. The method of claim 1, further comprising:
receiving, from the cloud-based platform, an indication of one or more Mode 2 sidelink parameters that are based at least in part on at least one of:
the Mode 2 sidelink measurement report, or
other Mode 2 sidelink measurement reports associated with one or more other UEs of the plurality of UEs; and
communicating on a sidelink based at least in part on the one or more Mode 2 sidelink parameters.

10. The method of claim 1, wherein transmitting the Mode 2 sidelink measurement report comprises:
transmitting, during a reporting time window, the Mode 2 sidelink measurement report in a physical sidelink shared channel (PSSCH) communication that is dedicated for Mode 2 sidelink measurement reporting.

11. The method of claim 1, wherein transmitting the Mode 2 sidelink measurement report comprises:
transmitting the Mode 2 sidelink measurement report in a physical sidelink shared channel (PSSCH) communication that is configured for transmitting sidelink data,
wherein the PSSCH communication indicates that the Mode 2 sidelink measurement report is directed to the cloud-based platform.

12. The method of claim 1, wherein the configuration indicates whether to transmit the Mode 2 sidelink measurement report in a dedicated physical sidelink shared channel (PSSCH) communication or in a PSSCH communication that is configured for transmitting sidelink data.

13. The method of claim 1, wherein transmitting the Mode 2 sidelink measurement report comprises:
transmitting the Mode 2 sidelink measurement report in a sidelink communication in which the Mode 2 sidelink measurement report is multiplexed with at least one of:
one or more other Mode 2 sidelink measurement reports that were generated for the particular geographic area, or
one or more other Mode 2 sidelink measurement reports that were generated for another geographic area.

14. The method of claim 1, wherein transmitting the Mode 2 sidelink measurement report comprises:
transmitting the Mode 2 sidelink measurement report on a sidelink to a roadside unit (RSU) for aggregation of the Mode 2 sidelink measurement report with one or more other Mode 2 sidelink measurement reports associated with at least a subset of the plurality of UEs.

15. The method of claim 1, wherein the UE comprises a roadside unit (RSU), or
wherein the UE is associated with a vehicle.

16. A method of wireless communication performed by a cloud-based platform, comprising:
transmitting a configuration for Mode 2 sidelink measurement reporting to a plurality of user equipments (UEs) in a particular geographic area; and
receiving, from at least a subset of the plurality of UEs, Mode 2 sidelink measurement reports based at least in part on the configuration.

17. The method of claim 16, further comprising:
transmitting, to a UE of the plurality of UEs, a request for another Mode 2 sidelink measurement report; and
receiving, from the UE, the other Mode 2 sidelink measurement report.

18. The method of claim 16, further comprising:
receiving, from a UE of the plurality of UEs, additional Mode 2 sidelink measurement reports at a particular periodicity based at least in part on an indication of the particular periodicity in the configuration.

19. The method of claim 16, further comprising:
transmitting, to the plurality of UEs, an indication of one or more Mode 2 sidelink parameters that are based at least in part on at least a subset of the Mode 2 sidelink measurement reports.

20. The method of claim 16, wherein receiving the Mode 2 sidelink measurement reports comprises:
receiving, from a UE of the plurality of UEs and during a reporting time window, a Mode 2 sidelink measurement report of the Mode 2 sidelink measurement reports in a physical sidelink shared channel (PSSCH) communication that is dedicated for Mode 2 sidelink measurement reporting.

21. The method of claim 16, wherein receiving the Mode 2 sidelink measurement reports comprises:
receiving, from a UE of the plurality of UEs, a Mode 2 sidelink measurement report of the Mode 2 sidelink measurement reports in a physical sidelink shared channel (PSSCH) communication that is configured for transmitting sidelink data,
wherein the PSSCH communication indicates that the Mode 2 sidelink measurement report is directed to the cloud-based platform.

22. The method of claim 16, wherein the configuration indicates whether to transmit the Mode 2 sidelink measurement reports in dedicated physical sidelink shared channel (PSSCH) communications or in PSSCH communications that are configured for transmitting sidelink data.

23. The method of claim 16, wherein receiving the Mode 2 sidelink measurement report comprises:
receiving, from a UE of the plurality of UEs, a Mode 2 sidelink measurement report of the Mode 2 sidelink measurement reports in a sidelink communication in which the Mode 2 sidelink measurement report is multiplexed with at least one of:
one or more other Mode 2 sidelink measurement reports that were generated for the particular geographic area, or
one or more other Mode 2 sidelink measurement reports that were generated for another geographic area.

24. A user equipment (UE) for wireless communication, comprising:
a memory; and
one or more processors, coupled to the memory, configured to:
receive, from a cloud-based platform, a configuration for Mode 2 sidelink measurement reporting,
wherein the configuration is associated with a plurality of UEs in a particular geographic area, and
wherein the UE is included among the plurality of UEs; and
transmit, to the cloud-based platform, a Mode 2 sidelink measurement report based at least in part on the configuration.

25. The UE of claim 24, wherein the Mode 2 sidelink measurement report indicates at least one of:
results of one or more measurements, or
one or more parameters associated with the UE,
wherein the one or more measurements include at least one of:
a sidelink transmit power measurement, or
a sidelink receive power measurement; and
wherein the one or more parameters associated with the UE include at least one of:
a quantity of packets transmitted by the UE in a particular time duration, or
a quantity of packets decoded by the UE in a particular time duration.

26. The UE of claim 25, wherein the Mode 2 sidelink measurement report includes explicit values for at least one of the results of the one or more measurements or the one or more parameters associated with the UE.

27. The UE of claim 25, wherein the Mode 2 sidelink measurement report includes a qualitative indicator for at least one of the results of the one or more measurements or the one or more parameters associated with the UE.

28. A cloud-based platform for wireless communication, comprising:
a memory; and
one or more processors, coupled to the memory, configured to:
transmit a configuration for Mode 2 sidelink measurement reporting to a plurality of user equipments (UEs) in a particular geographic area; and
receive, from at least a subset of the plurality of UEs, Mode 2 sidelink measurement reports based at least in part on the configuration.

29. The cloud-based platform of claim 28, wherein the one or more processors are further configured to:
transmit, to a UE of the plurality of UEs, a request for another Mode 2 sidelink measurement report; and
receive, from the UE, the other Mode 2 sidelink measurement report.

30. The cloud-based platform of claim 28, wherein the one or more processors are further configured to:
receive, from a UE of the plurality of UEs, additional Mode 2 sidelink measurement reports at a particular periodicity based at least in part on an indication of the particular periodicity in the configuration.
